(19) United States
(12) Patent Application Publication
(10) Pub. No.: US 2021/0135277 A1
(43) Pub. Date: May 6, 2021

(54) AQUEOUS RECHARGEABLE BATTERY

(71) Applicant: Panasonic Intellectual Property Management Co., Ltd., Osaka-shi, Osaka (JP)

(72) Inventors: Nobuhiko Hojo, Osaka (JP); Hiroyuki Matsumoto, Tokyo (JP); Kenji Matsubara, Kanagawa (JP); Hiroshi Kawada, Hyogo (JP); Atsushi Fukui, Hyogo (JP)

(73) Assignee: Panasonic Intellectual Property Management Co., Ltd., Osaka-shi, Osaka (JP)

(21) Appl. No.: 16/640,116

(22) PCT Filed: Sep. 21, 2018
(86) PCT No.: PCT/JP2018/035061

§ 371 Date: Feb. 19, 2020

(30) Foreign Application Priority Data
Sep. 29, 2017 (JP) 2017-189356

(51) Int. Cl. H01M 10/0562; H01M 10/0525; H01M 4/505; H01M 4/525

(52) U.S. Cl. CPC H01M 10/0562; H01M 10/0525; H01M 2004/028; H01M 4/525; H01M 4/505

(57) ABSTRACT

An aqueous rechargeable battery includes: a positive electrode including a positive electrode current collector and a positive electrode active material layer provided on a surface of the positive electrode current collector; a negative electrode including a negative electrode current collector and a negative electrode active material layer provided on a surface of the negative electrode current collector; and an aqueous electrolyte solution containing a lithium salt and water. The positive electrode active material layer contains one or more positive electrode active materials and one or more lithium ion-conducting solid electrolytes; and the positive electrode active materials include a lithium transition metal oxide.

### TECHNICAL FIELD

The present disclosure relates to an aqueous rechargeable battery.

### BACKGROUND ART

A non-aqueous electrolyte secondary battery represented by a lithium-ion battery includes, to achieve a high energy density, an organic solvent that does not decompose even at a voltage of about 4 V as an electrolyte solution. However, organic solvents are generally flammable.

Meanwhile, by employing a concentrated aqueous solution of an alkali metal salt as an electrolyte of a lithium-ion battery, Patent Literature 1 discloses a power storage device that includes a flammable organic solvent-free aqueous electrolyte solution. Patent Literature 1 also discloses an aqueous electrolyte solution that does not decompose even at a voltage of 2 V by incorporating a high-concentration alkali metal salt as an electrolyte.

### CITATION LIST

### Patent Literature

PTL 1: International Publication No. 2016/114141

### SUMMARY OF INVENTION

Some of the aqueous electrolyte solutions disclosed in Patent Literature 1 exhibited unsatisfactory stability during storage of a battery in a charged state.

An aqueous rechargeable battery according to the present disclosure includes: a positive electrode including a positive electrode current collector and a positive electrode active material layer provided on a surface of the positive electrode current collector; a negative electrode including a negative electrode current collector and a negative electrode active material layer provided on a surface of the negative electrode current collector; and an aqueous electrolyte solution containing a lithium salt and water. The positive electrode active material layer contains one or more positive electrode active materials and one or more lithium ion-conducting solid electrolytes; and the positive electrode active materials include a lithium transition metal oxide.

According to the aqueous rechargeable battery of the present disclosure, it is possible to enhance storage stability in a charged state of an aqueous rechargeable battery that uses an electrolyte solution containing an aqueous solution.

### BRIEF DESCRIPTION OF DRAWINGS

FIG. 1 is a schematic cross-sectional view of an aqueous rechargeable battery according to an embodiment of the present disclosure.

### DESCRIPTION OF EMBODIMENTS

An aqueous rechargeable battery according to an embodiment includes: a positive electrode including a positive electrode current collector and a positive electrode active material layer provided on a surface of the positive electrode current collector; a negative electrode including a negative electrode current collector and a negative electrode active material layer provided on a surface of the negative electrode current collector; and an aqueous electrolyte solution containing a lithium salt and water. The positive electrode active material layer contains one or more positive electrode active materials and one or more lithium ion-conducting solid electrolytes; and the positive electrode active materials include a lithium transition metal oxide. In the description hereinafter, a lithium ion-conducting solid electrolyte is referred to as a solid electrolyte in some parts. Moreover, the term “aqueous rechargeable battery” means a rechargeable battery in which an electrolyte solution or an electrolyte contains water at least partially.

The causes of deteriorating stability during storage of a charged aqueous rechargeable battery will be described hereinafter. The wording “during storage of a charged aqueous rechargeable battery” herein means a state in which an aqueous rechargeable battery is stored in a charged state.

As a result of the intensive studies by the inventors, possible causes of deteriorating stability during storage of a charged aqueous rechargeable battery are the following two causes. One is the exchange reaction between lithium ions in the lithium transition metal oxide as a positive electrode active material and protons (hydrogen ions) generated upon decomposition of water in the electrolyte solution. The other is the insertion reaction of protons generated upon decomposition of water in the electrolyte solution into lithium sites of the positive electrode active material in a charged state in which lithium ions have been desorbed.

Through these two reactions, protons inserted into lithium sites of the positive electrode active material impedes insertion and desorption of lithium ions into and from the positive electrode active material, thereby causing lowering in battery capacity.

In light of these causes of deteriorating stability during storage of a charged aqueous rechargeable battery, possible mechanisms for improving stability during storage of a charged aqueous rechargeable battery of the present disclosure will be described next.

The aqueous rechargeable battery of the present disclosure can suppress lowering in battery capacity by including a lithium ion-conducting solid electrolyte in the positive electrode active material layer. The mechanisms will be described below by using an exemplary case in which the lithium ion-conducting solid electrolyte is lithium phosphate (Li₃PO₄).

As in formula 1, lithium phosphate reacts with protons and condenses with another lithium phosphate to form Li₄P₂O₇. In this step, protons are consumed, thereby suppressing the insertion reaction of protons into the positive electrode active material and/or the exchange reaction with lithium ions in the positive electrode active material. The formed Li₄P₂O₇, as in formula 2, further reacts with protons, condenses with another lithium phosphate to form Li₅P₃O₁₀ as well as further condensed polymers, such as polyphosphate salts. As described above, lithium phosphate consumes protons and thus can impede insertion of protons into lithium sites of the positive electrode active material. Moreover, since the formed polymers exhibit lithium ion conductivity, it is possible to maintain good lithium ion conductivity within the positive electrode plate and enhance stability of the positive electrode without deterioration in battery performance. Further, since water is a component originally contained in the aqueous electrolyte solution, there is no concern of side reactions due to water (formula 2) generated through the condensation reactions.

2Li₃PO₄+2H+=2Li⁺+Li₄P₂O₇+H₂O (formula 1)

Li₄P₂O₇+Li₃PO₄+2H⁺=2Li⁺+Li₅P₃O₁₀+H₂O (formula 2)

The above condensation reactions are described using an exemplary case in which the lithium ion-conducting solid electrolyte is lithium phosphate (Li₃PO₄), but the reactions are not limited to lithium phosphate. Similar condensation reactions are possible in a case in which lithium ion-conducting solid electrolytes include one or more lithium ion-permeable oxides X represented by LiₓM¹O_{y} (0.5≤x<4, 1≤y≤6); and M¹ is at least one selected from the group consisting of B, Al, Si, P, S, Ti, V, Zr, Nb, Ta, and La. Through such condensation reactions, polymers containing elemental M¹, elemental oxygen, and elemental lithium are formed. Such polymers are also contained in the positive electrode active material layer.

The lithium ion-conducting solid electrolyte preferably covers at least part of a surface of the positive electrode active material. Since physical contact between the positive electrode active material and water contained in the electrolyte can be suppressed, generation of protons due to side reactions of water on the positive electrode active material can be suppressed. In addition, by covering the surface of the positive electrode active material with the lithium ion-conducting solid electrolyte, insertion of protons into the positive electrode active material can be suppressed. Moreover, by covering the surface of the positive electrode active material with the lithium ion-conducting solid electrolyte, protons generated on the surface of the positive electrode active material are consumed to form polymers of the solid electrolyte on the surface of the positive electrode active material. Due to such polymers, it is considered possible to enhance the stability of the positive electrode.

The lithium ion-conducting solid electrolyte preferably covers at least part of a surface of the positive electrode current collector. Since physical contact between the positive electrode current collector and water contained in the electrolyte can be suppressed, generation of protons due to side reactions of water on the positive electrode current collector can be suppressed. By covering the surface of the positive electrode current collector with the lithium ion-conducting solid electrolyte, protons generated on the surface of the positive electrode current collector are consumed to form polymers of the solid electrolyte on the surface of the positive electrode current collector. Due to such polymers, it is considered possible to enhance the stability of the positive electrode.

When the positive electrode active material layer further contains a conductive agent, the lithium ion-conducting solid electrolyte preferably covers at least part of a surface of the conductive agent. Since physical contact between the conductive agent and water contained in the electrolyte can be suppressed, generation of protons due to side reactions of water on the conductive agent can be suppressed. By covering the surface of the conductive agent with the lithium ion-conducting solid electrolyte, protons generated on the surface of the conductive agent are consumed to form polymers of the solid electrolyte on the surface of the conductive agent. Due to such polymers, it is considered possible to enhance the stability of the positive electrode.

Hereinafter, the aqueous rechargeable battery of the embodiment will be described in detail by means of the drawing. However, the configuration of the aqueous rechargeable battery is not limited to such an example.

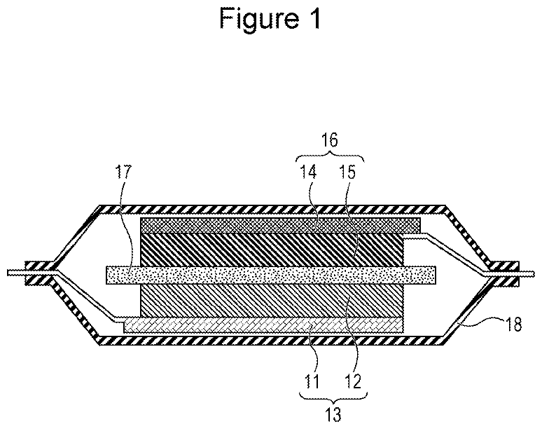

FIG. 1 is a schematic cross-sectional view of an aqueous rechargeable battery according to an embodiment of the present disclosure. The aqueous rechargeable battery illustrated in FIG. 1 includes a positive electrode 13 and a negative electrode 16. The positive electrode 13 includes a positive electrode current collector 11 and a positive electrode active material layer 12 formed on the positive electrode current collector 11. The positive electrode active material layer 12 contains a positive electrode active material. The negative electrode 16 includes a negative electrode current collector 14 and a negative electrode active material layer 15 formed on the negative electrode current collector 14. The negative electrode active material layer 15 contains a negative electrode active material. The positive electrode 13 and the negative electrode 16 are disposed such that the positive electrode active material layer 12 and the negative electrode active material layer 15 face each other via a separator 17, thereby forming an electrode assembly. Inside a case 18, the electrode assembly and an aqueous electrolyte solution (not shown) are placed.

Hereinafter, each component will be described in further detail.

(Positive Electrode)

The positive electrode includes a sheet-like positive electrode current collector, a positive electrode active material layer provided on the surface of the positive electrode current collector, and a lithium ion-conducting solid electrolyte introduced into the positive electrode active material layer. The positive electrode active material layer may be formed on either surface or both surfaces of the positive electrode current collector.

(Positive Electrode Current Collector)

Examples of the positive electrode current collector include a metal foil and a metal sheet. As a material for the positive electrode current collector, stainless steel, aluminum, an aluminum alloy, titanium, or the like may be used. The thickness of the positive electrode current collector may be selected from the range of 3 to 50 μm, for example.

(Positive Electrode Active Material Layer)

A case in which the positive electrode active material layer is a mixture containing positive electrode active material particles will be described. The positive electrode active material layer contains a positive electrode active material, a lithium ion-conducting solid electrolyte, and a binder as essential components and may further contain a conductive agent as an optional component. The amount of the binder contained in the positive electrode active material layer is preferably 0.1 to 20 parts by mass and more preferably 1 to 5 parts by mass relative to 100 parts by mass of the positive electrode active material. The thickness of the positive electrode active material layer is 10 to 100 μm, for example.

The positive electrode active material is preferably a lithium transition metal oxide. Exemplary transition metal elements include Sc, Y, Mn, Fe, Co, Ni, Cu, and Cr. Among these elements, Mn, Co, Ni, and the like are preferable. When the transition metal is Co alone, the oxide is LiCoO₂. The lithium transition metal oxide is more preferably lithium nickel complex oxide containing Li, Ni, and other metals.

Examples of the lithium nickel complex oxide include LiₐNi_{b}M³_{1-b}O₂ (M³ is at least one selected from the group consisting of Mn, Co, and Al; 0<a≤1.2; 0.3≤b≤1). To enhance capacity, 0.55≤b≤1 is more preferable, and 0.8≤b≤1 is further preferably satisfied. In view of the stability of the crystal structure, LiₐNi_{b}Co_{c}Al_{d}O₂ (0<a≤1.2, 0.8≤b<1, 0<c<0.2, 0<d≤0.1, b+c+d=1) containing Co and Al as M³ is further preferable.

Specific examples of the lithium nickel complex oxide include lithium nickel cobalt manganese complex oxide (LiNi_{0.5}Co_{0.2}Mn_{0.3}O₂, LiNi_{1/3}Co_{1/3}Mn_{1/3}O₂, LiNi_{0.4}Co_{0.2}Mn_{0.4}O₂, for example), lithium nickel manganese complex oxide (LiNi_{0.5}Mn_{0.5}O₂, LiNi_{0.5}Mn_{1.5}O₄, for example), lithium nickel cobalt complex oxide (LiNi_{0.8}Co_{0.2}O₂, for example), and lithium nickel cobalt aluminum complex oxide (LiNi_{0.8}Co_{0.15}Al_{0.05}O₂, LiNi_{0.8}Co_{0.18}Al_{0.02}O₂, LiNi_{0.88}Co_{0.09}Al_{0.03}O₂, for example).

To enhance filling properties of the positive electrode active material in the positive electrode active material layer, the average particle size (D50) of the positive electrode active material particles is desirably sufficiently small relative to the thickness of the positive electrode active material layer. The average particle size (D50) of the positive electrode active material particles is preferably 5 to 30 μm and more preferably 10 to 25 μm, for example. The average particle size (D50) herein means a median diameter at 50% cumulative volume in the volume-based particle size distribution. The average particle size is measured by using, for example, a laser diffraction/scattering-type particle size distribution analyzer.

Examples of the binder include fluororesins, such as polyvinylidene fluoride (PVdF), polytetrafluoroethylene (PTFE), and tetrafluoroethylene-hexafluoropropylene copolymer (HFP); acrylic resins, such as polymethyl acrylate and ethylene-methyl methacrylate copolymer; rubber materials, such as styrene-butadiene rubber (SBR) and acrylic rubber; and water-soluble polymers, such as carboxymethyl cellulose (CMC) and polyvinylpyrrolidone.

As the conductive agent, carbon black, such as acetylene black or Ketjen black, is preferable.

The positive electrode active material layer can be formed by: preparing a positive electrode slurry through mixing of positive electrode active material particles, a lithium ion-conducting solid electrolyte, a binder, and the like together with a dispersion medium; applying the positive electrode slurry to the surface of a positive electrode current collector; drying; and then rolling. As the dispersion medium, water; alcohols, such as ethanol; ethers, such as tetrahydrofuran; N-methyl-2-pyrrolidone (NMP); or the like is used. When water is used as the dispersion medium, a rubber material and a water-soluble polymer are preferably used in combination as a binder.

(Lithium Ion-Conducting Solid Electrolyte)

It is preferable that the lithium ion-conducting solid electrolytes include one or more lithium ion-permeable oxides X represented by LiₓM¹O_{y} (0.5≤x<4, 1≤y<6) and M¹ is at least one selected from the group consisting of B, Al, Si, P, S, Ti, V, Zr, Nb, Ta, and La. The lithium ion-conducting solid electrolytes are stable to water and exhibit lithium ion conductivity. By including a lithium ion-conducting solid electrolyte in the positive electrode active material layer, protons are consumed and polymers formed during consumption of protons also exhibit lithium ion conductivity.

M¹ is more preferably at least one selected from the group consisting of P, Si, and B since raw materials therefor are inexpensive. Elemental M¹ is further preferably contains at least P.

The lithium ion-conducting solid electrolytes preferably further include one or more compounds Y containing fluorine. The compound Y included in the lithium ion-conducting solid electrolytes has a bond between a metal element M² and elemental fluorine, and M² may be at least one selected from the group consisting of Li, Na, Al, Mg, and Ca. In particular, it is more preferable that M² contains Li and the compounds Y include LiF. By including the compound Y containing fluorine in the lithium ion-conducting solid electrolytes, it is possible to form chemically stable lithium ion-conducting solid electrolytes.

The oxides X represented by compositional formula LiₓM¹O_{y} have ionic O—Li bonds and exhibit lithium ion permeability through hopping of lithium ions via the O sites. The oxides X are preferably polyoxometalates in view of safety. Here, the rages of x and y are preferably 0.5≤x<4 and 1≤y<6, for example.

As the polyoxometalates, Li₃PO₄, Li₄SiO₄, Li₂Si₂O₅, Li₂SiO₃, Li₃BO₃, Li₃VO₄, Li₃NbO₄, LiZr₂ (PO₄), LiTaO₃, Li₄Ti₅O₁₂, Li₇La₃Zr₂O₁₂, Li₅La₃Ta₂O₁₂, Li_{0.35}La_{0.55}TiO₃, Li₉SiAlO₈, Li_{1.3}Al_{0.3}Ti_{1.7}(PO₄)₃, and so forth may be used alone or in any combination. As the composition of the oxides X, it is more preferable to include at least Li₃PO₄, and it is also preferable to include 80% or more of Li₃PO₄ and 20% or less of lithium silicate. Examples of the lithium silicate include Li₄SiO₄, Li₂Si₂O₅, and Li₂SiO₃.

In the polyoxometalates, the compositional ratios of lithium and oxygen need not agree with the stoichiometric composition. Rather, when the oxygen compositional ratio in the oxides X is smaller than the stoichiometric composition, lithium ion permeability is readily exhibited due to the presence of oxygen deficiency. Specifically, when the oxide X is lithium phosphate, Li_{X}PO_{Y} (1≤x<3, 3≤y<4) is more preferable, and when the oxide X is lithium silicate, LiₓSiO_{y} (2≤x<4, 3≤y<4) is more preferable.

The lithium ion-conducting solid electrolyte preferably covers at least part of the surface of the positive electrode active material, the surface of the positive electrode current collector, and the surface of the conductive agent.

When the lithium ion-conducting solid electrolyte covers at least part of the surface of the positive electrode active material, it is desirable to form a homogenous layer that covers, in a necessary and sufficient amount, the surface of the positive electrode active material layer (hereinafter, a homogeneous layer of the lithium ion-conducting solid electrolyte that covers the surface of the positive electrode active material layer is referred to as a coating layer consisting of the lithium ion-conducting solid electrolyte or simply referred to as a coating layer). The thickness of the coating layer is desirably smaller than the average particle size of the positive electrode active material particles and is preferably 0.1 μm (100 nm) or less and more preferably 0.03 μm (30 nm) or less, for example. Meanwhile, in some cases, an excessively small thickness of the coating layer causes carrier (electron or hole) migration due to the tunneling effect or the like to progress, thereby allowing oxidative decomposition of the aqueous electrolyte solution to progress. In view of suppressed carrier migration and smooth transfer of lithium ions, the thickness of the coating layer is preferably 0.5 nm or more.

The coating layer can be formed after forming the positive electrode active material layer. As a result, the coating layer could possibly be absent in some regions, such as contact interfaces between positive electrode active material particles and bonding interfaces between positive electrode active material particles and a binder.

The coating layer consisting of the lithium ion-conducting solid electrolyte may be formed from a material having a lithium ion conductivity of 1.0×10⁻¹¹ S/cm or more, for example. Meanwhile, from a viewpoint of suppressing oxidative decomposition of the aqueous electrolyte solution as much as possible, the coating layer consisting of the lithium ion-conducting solid electrolyte desirably has low electric conductivity and desirably has a conductivity of less than 1.0×10⁻² S/cm.

To ensure the positive electrode capacity, the content, in the positive electrode, of the coating layer consisting of the lithium ion-conducting solid electrolyte is desirably as small as possible. The amount of the coating layer consisting of the lithium ion-conducting solid electrolyte in the positive electrode is preferably 0.01 to 10 parts by mass and more preferably 0.05 to 5 parts by mass relative to 100 parts by mass of the positive electrode active material layer.

Hereinafter, a production method for a positive electrode in which a lithium ion-conducting solid electrolyte covers at least part of the surface of a positive electrode active material will be described. For example, such a positive electrode can be produced by (i) a step of preparing a positive electrode precursor including a positive electrode current collector and a positive electrode active material layer provided on the surface of the positive electrode current collector, followed by (ii) a step of covering at least part of the surface of the positive electrode active material layer with the lithium ion-conducting solid electrolyte while partially covering the surface of the positive electrode current collector.

In step (ii), a coating layer consisting of the lithium ion-conducting solid electrolyte is formed through exposure of the positive electrode precursor to an atmosphere containing raw materials for the lithium ion-conducting solid electrolyte. In this step, the atmosphere containing the raw materials for the lithium ion-conducting solid electrolyte is preferably 200° C. or lower and more preferably 120° C. or lower. The coating layer consisting of the lithium ion-conducting solid electrolyte is preferably formed by a liquid phase method or a gas phase method.

The liquid phase method is preferably a precipitation method, a sol gel process, and so forth. The precipitation method refers to, for example, a method of immersing the positive electrode precursor in a solution at a temperature sufficiently lower than 200° C. in which raw materials for the lithium ion-conducting solid electrolyte are dissolved, thereby precipitating constituent materials of the lithium ion-conducting solid electrolyte on the surfaces of the positive electrode active material layer and/or the positive electrode current collector. Meanwhile, the sol gel process refers to, for example, a method of immersing the positive electrode precursor in a liquid at a temperature sufficiently lower than 200° C. containing raw materials for the lithium ion-conducting solid electrolyte; followed by deposition and gelation of intermediate particles for the lithium ion-conducting solid electrolyte on the surfaces of the positive electrode active material layer and/or the positive electrode current collector.

Examples of the gas phase method include physical vapor deposition (PVD), chemical vapor deposition (CVD), and atomic layer deposition (ALD). PVD and CVD are usually carried out at a high temperature exceeding 200° C. Meanwhile, according to ALD, a coating layer consisting of a lithium ion-conducting solid electrolyte can be formed in an atmosphere of 200° C. or lower or even 120° C. or lower containing raw materials for the lithium ion-conducting solid electrolyte.

In ALD, organic compounds with high vapor pressure are used as raw materials for a lithium ion-conducting solid electrolyte. Vaporization of such raw materials allows molecular raw materials to interact with the surfaces of the positive electrode active material layer and/or the positive electrode current collector. Such molecular raw materials readily reach voids inside the positive electrode active material layer. Consequently, a homogeneous coating layer consisting of the lithium ion-conducting solid electrolyte tends to be formed even on the inner walls of the voids.

In ALD, a coating layer consisting of a lithium ion-conducting solid electrolyte that covers the positive electrode active material layer and/or the positive electrode current collector is formed through the following procedure, for example.

When an oxide X is formed by ALD, at first, a first raw material gas is introduced into a reaction chamber where the positive electrode precursor is placed. After that, when the surface of the positive electrode precursor has been covered with a monomolecular layer of the first raw material, the first raw material is no longer adsorbed onto the surface of the positive electrode precursor due to the self-limiting mechanism of the organic group of the first raw material. Excessive first raw material is purged from the reaction chamber by an inert gas or the like.

Next, a second raw material gas is introduced into the reaction chamber where the positive electrode precursor is placed. When the reaction between the second raw material and the monomolecular layer of the first raw material ends, the second raw material is no longer adsorbed onto the surface of the positive electrode precursor. Excessive second raw material is purged from the reaction chamber by an inert gas or the like.

As described above, a coating of lithium oxide X containing elemental M¹ and lithium is formed by repeating a predetermined number of times a series of operations consisting of introduction of a first raw material, purging, introduction of a second raw material, and purging.

Materials used as the first raw material and the second raw material are not particularly limited, and appropriate compounds may be selected depending on desirable oxides X. Examples of the first raw material include materials containing phosphorus as elemental M¹ (trimethyl phosphate, triethyl phosphate, tris(dimethylamino)phosphine, and trimethylphosphine, for example); materials containing silicon as elemental M¹ (tetramethyl orthosilicate and tetraethyl orthosilicate, for example); materials containing both elemental M¹ and lithium (lithium bis(trimethylsilyl)amide, for example); and lithium source materials (lithium tert-butoxide and lithium cyclopentadienide, for example).

When a material containing elemental M¹ is used as the first raw material, a lithium source material (or a material containing both elemental M¹ and lithium) is used as the second raw material. When a lithium source material is used as the first raw material, a material containing elemental M¹ (or a material containing both elemental M¹ and lithium) is used as the second raw material. When a material containing both elemental M¹ and lithium is used as the first raw material, an oxidizing agent (oxygen or ozone, for example) may be used as the second raw material.

When a compound Y containing fluorine is formed by ALD after deposition of an oxide X, processing similar to deposition of the oxide X may be performed by changing the first and the second raw materials. Materials used as the first and the second raw materials are not particularly limited, and appropriate compounds may be selected depending on desirable compounds Y. For example, when lithium is contained as a metal element M², the above-described lithium source materials may be used. Moreover, exemplary source materials of other metal elements M² (sodium, aluminum, potassium, magnesium, calcium) include tert-butoxides of these metal elements.

Exemplary fluorine source materials include fluorine gas, HF gas, and NH₄F. Exemplary materials containing both a metal element M² and fluorine include LiF.

A first coating can be formed by successive deposition of an oxide X and a compound Y. The coating layer consisting of a lithium ion-conducting solid electrolyte may be a two-layer structure of a compound Y film formed on an oxide X film or may be a multilayer film of alternately deposited oxide X films and compound Y films.

It is also possible to deposit an oxide X and a compound Y at the same time by simultaneously feeding, as the first and the second raw materials, raw material gases for depositing the oxide X and the compound Y to a reaction chamber. In this case, the oxide X and the compound Y coexist within the same atomic layer on the surface of a coating layer consisting of a lithium ion-conducting solid electrolyte. In this case, side reactions are highly effectively suppressed since a highly chemically stable coating is formed due to the compound Y on the surface of the coating layer consisting of the lithium ion-conducting solid electrolyte. Moreover, without obstructing lithium ion permeation by the compound Y on the surface of the lithium ion-conducting solid electrolyte, it is possible to permeate lithium ions into a positive electrode active material (from the positive electrode active material) through the oxide X present on the surface of the lithium ion-conducting solid electrolyte.

In both deposition of an oxide X and deposition of a compound Y, to promote reactions of each raw material, an oxidizing agent may be used in combination with other raw materials by introducing the oxidizing agent into a reaction chamber at a suitable time. The oxidizing agent may be introduced at a suitable time or every time in repeated series of operations.

Further, three or more raw materials may be used. In other words, in addition to the first and the second raw materials, one or more raw materials may be used further. For example, a series of operations consisting of introduction of a first raw material, purging, introduction of a second raw material, purging, introduction of a third raw material different from the first and the second raw materials, and purging may be repeated.

When binders include a fluorine compound, such as polyvinylidene fluoride (PVdF), part of the fluorine compound in the binders may be sublimed within a reaction chamber. The sublimed fluorine compound acts as a fluorine source in ALD. Accordingly, when a fluorine compound is used as a binder, only materials required for deposition of an oxide X may be selected as the first and the second raw materials. As a result of fluorine supplied from the binder, it is possible to form a coating layer consisting of a lithium ion-conducting solid electrolyte in which an oxide X and a compound Y having a lithium-fluorine bond (LiF) coexist within the same atomic layer.

Deposition methods for an oxide X and a compound Y are preferably the same but may be different. For example, deposition of either an oxide X or a compound Y may be performed by a liquid phase method, and deposition of the other may be performed by a gas phase method.

(Negative Electrode)

A negative electrode includes a sheet-like negative electrode current collector and a negative electrode active material layer provided on the surface of the negative electrode current collector. The negative electrode active material layer may be formed on either surface or both surfaces of the negative electrode current collector.

(Negative Electrode Current Collector)

Examples of the negative electrode current collector include a metal foil, a metal sheet, a mesh, a punching sheet, and an expanded metal. As a material for the negative electrode current collector, stainless steel, nickel, copper, a copper alloy, aluminum, an aluminum alloy, or the like may be used. The thickness of the negative electrode current collector may be selected from the range of 3 to 50 μm, for example.

(Negative Electrode Active Material Layer)

The negative electrode active material layer can be formed by using a negative electrode slurry containing a negative electrode active material, a binder, and a dispersion medium by a method according to the production of a positive electrode active material layer. The negative electrode active material layer may further contain optional components, such as a conductive agent, as necessary. The amount of the binder contained in the negative electrode active material layer is preferably 0.1 to 20 parts by mass and more preferably 1 to 5 parts by mass relative to 100 parts by mass of the negative electrode active material. The thickness of the negative electrode active material layer is 10 to 100 μm, for example.

The negative electrode active material may be a non-carbonaceous material, a carbon material, or a combination thereof. As the non-carbonaceous material used for the negative electrode active material, lithium-containing metal oxides of titanium, tantalum, niobium, or the like as well as alloy materials are preferable. The alloy materials preferably contain silicon or tin, and elemental silicon and silicon compounds are particularly preferable. The silicon compounds encompass silicon oxide and silicon alloys. Meanwhile, the carbon material used as the negative electrode active material is not particularly limited but is preferably at least one selected from the group consisting of graphite and hard carbon, for example. The term “graphite” is a generic term for carbon materials having the graphite structure and encompasses natural graphite, synthetic graphite, expanded graphite, graphitized mesophase carbon particles, and the like. Examples of the natural graphite include flake graphite and amorphous graphite. In general, a carbon material having the graphite structure with (002) interplanar spacing d₀₀₂ of 3.35 to 3.44 Å calculated from the X-ray diffraction spectrum is classified as graphite. Meanwhile, hard carbon is a carbon material in which minute graphite crystals are arranged in random directions and further graphitization scarcely progresses. Hard carbon has (002) interplanar spacing d₀₀₂ of more than 3.44 Å.

(Separator)

As a separator, a microporous film, a nonwoven fabric, a woven fabric, or the like containing a material selected from resins, glass, ceramics, and so forth is used. As the resins, for example, polyolefins, such as polyethylene and polypropylene; polyamides; and polyamide-imides are used. As the glass and ceramics, for example, borosilicate glass, silica, alumina, and titania are used.

(Aqueous Electrolyte Solution)

As an aqueous electrolyte solution, an electrolyte solution containing an aqueous solution of a lithium salt in water may be used. Since the solvent is nonflammable water, a safe rechargeable battery can be obtained.

Examples of the lithium salt include LiCF₃SO₃, LiN(SO₂CF₃)₂, LiN(SO₂CF₂)₂, LiN(SO₂C₂F₅)₂, and LiN(SO₂CF₃)(SO₂C₂F₅). The lithium salt may be used alone or in combination. These lithium salts are suitably used due to high solubility in water as a solvent as well as high stability to water.

Moreover, the lithium salt may be formed from a lithium cation and an imide anion. In particular, LiN(SO₂CF₃)₂ and LiN(SO₂C₂F₅)₂ are suitably used. The amount of water relative to 1 mol of the lithium salt is preferably 4 mol or less. Meanwhile, the amount of water relative to 1 mol of the lithium salt is preferably 1.5 mol or more. As a result, it is possible to lower water activity, widen the potential window of the aqueous electrolyte solution, and enhance the voltage of an aqueous rechargeable battery to a high voltage of 2 V or more.

To control the pH of the aqueous electrolyte solution, an acid and/or an alkali may be added. As the acid, CF₃SO₃H, HN(SO₂CF₃)₂, or HN(SO₂C₂F₅)₂, which has an imide anion, may be added. Moreover, as the alkali, LiOH may be added. To enhance the voltage of an aqueous rechargeable battery to a high voltage of 2 V or more, addition of an alkali or LiOH is effective.

### EXAMPLES

Hereinafter, the present disclosure will be specifically described on the basis of Examples and Comparative Examples. The present disclosure, however, is not limited to the following Examples.

### Example 1

According to the following procedure, an aqueous rechargeable battery was produced.

(1) Production of Positive Electrode

A positive electrode slurry was prepared by mixing a lithium transition metal oxide (LiNi_{0.88}Co_{0.09}Al_{0.03}O₂ (NCA)) as a positive electrode active material containing Li, Ni, Co, and Al, acetylene black (AB) as a conductive agent, and polyvinylidene fluoride (PVdF) as a binder in a mass ratio of NCA:AB:PVdF=100:1:0.9, further adding an appropriate amount of N-methyl-2-pyrrolidone (NMP), and stirring. The obtained positive electrode slurry was then applied to either surface of an aluminum foil (positive electrode current collector), followed by drying. The resulting coating of the positive electrode mixture was rolled with a roller to produce a positive electrode precursor.

The positive electrode precursor was placed within a predetermined reaction chamber, and a lithium ion-conducting solid electrolyte was introduced into a positive electrode according to the following procedure. In this Example, at least part of the surface of the positive electrode active material, the surface of the conductive agent, the surface of the binder, and the surface of the positive electrode current collector is covered with the lithium ion-conducting solid electrolyte.

(i) A first raw material (trimethyl phosphate) as a source of elemental M¹ (phosphorus: P) and oxygen (O) was vaporized and introduced into the reaction chamber where the positive electrode precursor was placed. The atmosphere containing the first raw material was controlled to a temperature of 120° C. and a pressure of 260 Pa. After 30 seconds, excessive first raw material was purged by nitrogen gas on the assumption that the surface of the positive electrode precursor had been covered with a monomolecular layer of the first raw material.

(ii) Subsequently, a second raw material (lithium bis(trimethylsilyl)amide) as a lithium source was vaporized and introduced into the reaction chamber where the positive electrode precursor was placed. The atmosphere containing the second raw material was controlled to a temperature of 120° C. and a pressure of 260 Pa. After 30 seconds, excessive second raw material was purged by nitrogen gas on the assumption that the monomolecular layer of the first raw material had reacted with the second raw material.

(iii) A series of operations consisting of introduction of the first raw material, purging, introduction of the second raw material, and purging were repeated 100 times to form a coating layer consisting of a lithium ion-conducting solid electrolyte containing an oxide X and a compound Y.

The composition of the solid electrolyte was analyzed by XPS, ICP, and so forth, and lithium phosphate was confirmed to have been formed as a lithium ion-conducting solid electrolyte.

Moreover, in the analysis of the XPS spectrum, a fluorine 1s spectral peak attributed to Li—F and a fluorine is spectral peak attributed to PVdF were observed at 685 eV (±1 eV) and 688 eV (±2 eV), respectively. This revealed that fluorine of PVdF contained in the positive electrode precursor exists in a bonded state with lithium.

The mass of the first coating relative to the total mass of the positive electrode active material layer was obtained from the mass of the positive electrode precursor before formation of the solid electrolyte, the mass of the positive electrode after formation of the solid electrolyte, as well as the composition and the specific gravity of each material of the positive electrode active material layer. The result was 0.1 part by mass relative to 100 parts by mass of the positive electrode active material layer.

The thickness of the solid electrolyte is expected to fall within the range of 10 nm to 25 nm from the number of times the series of operations repeated in ALD.

The positive electrode precursor in which the solid electrolyte had been formed was cut into a predetermined electrode size to produce a positive electrode having the positive electrode active material layer on either surface of the positive electrode current collector.

(2) Production of Negative Electrode

A negative electrode slurry was prepared by mixing lithium titanate particles (average particle size (D50) of 7 μm) as a negative electrode active material, a binder, and a conductive agent with an appropriate amount of NMP solvent. As the conductive agent, carbon black was used, and PVdF was used as the binder. Relative to 100 parts by mass of lithium titanate particles, 5 parts by mass of carbon black and 10 parts by mass of PVdF were added. The obtained negative electrode slurry was then applied to either surface of a 10 μm-thick aluminum foil (negative electrode current collector), followed by drying. The resulting coating of the negative electrode mixture was rolled with a roller. Finally, the obtained stacked structure of the negative electrode current collector and the negative electrode mixture was cut into a predetermined electrode size to produce a negative electrode having the negative electrode active material layer on either surface of the negative electrode current collector.

(3) Preparation of Aqueous Electrolyte

An aqueous electrolyte solution was obtained by mixing LiN(SO₂CF₃)₂ (CAS registry No.: 90076-65-6), LiN(SO₂C₂F₅)₂ (CAS registry No.: 132843-44-8), and water in a molar ratio of 0.7:0.3:2.

(4) Production of Battery

An aluminum positive electrode lead was fixed to the positive electrode obtained as above, and an aluminum negative electrode lead was fixed to the negative electrode obtained as above. The positive electrode and the negative electrode were stacked such that the respective active material layer surfaces face each other via a 0.4 mm-thick glass nonwoven fabric separator to produce an electrode assembly.

The resulting electrode assembly was inserted between rectangular laminated films, and the negative electrode lead and the positive electrode lead were drawn outside the laminated films. Three sides of the rectangle of the laminated films were thermally fused. From the remaining one side, a predetermined amount of the aqueous electrolyte was fed inside the laminated films, and then the remaining one side was also thermally fused for sealing. A laminate aqueous rechargeable battery A1 was thus obtained. The aqueous rechargeable battery A1 was assessed on the basis of Evaluation 1 and Evaluation 2.

[Evaluation 1: Measurement of Discharge Capacity]

The battery was charged at a constant current of 0.5C to a closed-circuit voltage of 2.75 V and then discharged at a constant current of 0.5C to a closed-circuit voltage of 1.75 V to obtain a discharge capacity. The charge/discharge was performed in an environment of 25° C.

[Evaluation 2: Stability Evaluation During Storage in Charged State]

The battery was charged at a constant current of 0.5C to a closed-circuit voltage of 2.75 V and then disassembled to take out the positive electrode and the negative electrode. The positive electrode and the negative electrode taken out were immersed in the aqueous electrolyte solution prepared in (3) above in a beaker and stored at 25° C. for 1 hour. The positive electrode and the negative electrode after the storage were measured for a voltage difference between the positive electrode and the negative electrode to obtain a change rate (mV/Hour) in open-circuit voltage of the battery. The storage test in a charged state was performed in an environment of 25° C. The obtained change rate (mV/Hour) in open-circuit voltage was regarded as stability evaluation during storage in a charged state.

### Comparative Example 1

A positive electrode was produced in the same procedure as Example 1 except for omitting the step of forming the lithium ion-conducting solid electrolyte on the surface of the positive electrode precursor. An aqueous rechargeable battery B1 was produced by using the thus-produced positive electrode and assessed by Evaluation 1 and 2. In other words, the aqueous rechargeable battery B1 uses the positive electrode precursor of Example 1 as the positive electrode.

Evaluation results of Example 1 and Comparative Example 1 are shown in Table 1. In Table 1, the evaluation results of the aqueous rechargeable battery A1 are shown as cell A1 and the evaluation results of the aqueous rechargeable battery B1 as cell B1. In Table 1, the discharge capacities of the aqueous rechargeable battery A1 and the aqueous rechargeable battery B1 are shown in relative values with 100 for the discharge capacity of the aqueous rechargeable battery B1 of Comparative Example 1.

TABLE 1

| Cell | Discharge capacity | Change rate (mV/Hour) |
|---|---|---|
| A1 | 100 | −26 mV/Hour |
| B1 | 100 | −155 mV/Hour |

As shown in Table 1, by introducing a lithium ion-conducting solid electrolyte into the positive electrode, the aqueous rechargeable battery A1 of Example 1 was able to lower the change rate in open-circuit voltage during storage in a charged state, without lowering the discharge capacity, compared with the aqueous rechargeable battery B1 of Comparative Example 1. In other words, the aqueous rechargeable battery A1 can be evaluated that the stability during storage in a charged state is improved compared with the aqueous rechargeable battery B1.

The negative electrodes of the produced batteries comprise lithium titanate, which is a material with little potential variations at the negative electrodes. Accordingly, lowering in the change rate in open-circuit voltage means suppressed lowering in potential at the positive electrode. This reveals that introduction of a lithium ion-conducting solid electrolyte into the positive electrode active material layer made it possible to suppress lowering in potential at the positive electrode and improve storage stability of a battery in a charged state.

Moreover, the proportion (mass ratio) of the lithium ion-conducting solid electrolyte contained in the aqueous rechargeable battery A1 is sufficiently small of 0.1 part by mass relative to 100 parts by mass of the positive electrode active material. For this reason, the aqueous rechargeable battery A1 was presumably able to maintain a capacity comparable to the aqueous rechargeable battery B1, which lacks the lithium ion-conducting solid electrolyte.

### Example 2

In Example 2, a lithium transition metal oxide (LiNi_{0.82}Co_{0.15}Al_{0.03}O₂ (NCA)) was used as a positive electrode active material. An aqueous rechargeable battery A2 was produced in the same procedure as Example 1 except for changing the positive electrode active material. The aqueous rechargeable battery A2 was assessed on the basis of Evaluation 1 and 3.

[Evaluation 3: Stability Evaluation During Storage in Charged State]

The battery was charged at a constant current of 0.5C to a closed-circuit voltage of 2.75 V and then stored at 25° C. for 1 hour to obtain a potential difference between the positive and negative electrodes, in other words, a change rate (mV/Hour) in open-circuit voltage of the battery. The storage test in a charged state was performed in an environment of 25° C. The change rate (mV/Hour) in open-circuit voltage was regarded as stability evaluation during storage in a charged state.

### Comparative Example 2

In Comparative Example 2, an aqueous rechargeable battery B2 was produced in the same procedure as Example 2 except for omitting the step of forming the lithium ion-conducting solid electrolyte on the surface of the positive electrode precursor. In other words, the aqueous rechargeable battery B2 uses the positive electrode precursor of Example 2 as the positive electrode. The aqueous rechargeable battery B2 was assessed on the basis of Evaluation 1 and 3.

Evaluation results of Example 2 and Comparative Example 2 are shown in Table 2. In Table 2, the evaluation results of the aqueous rechargeable battery A2 are shown as cell A2 and the evaluation results of the aqueous rechargeable battery B2 as cell B2. In Table 2, the discharge capacities of the aqueous rechargeable battery A2 and the aqueous rechargeable battery B2 are shown in relative values with 100 for the discharge capacity of the aqueous rechargeable battery B2 of Comparative Example 2.

### Example 3

In Example 3, a lithium transition metal oxide (LiNi_{0.55}Co_{0.30}Mn_{0.15}O₂ (NCM)) was used as a positive electrode active material. An aqueous rechargeable battery A3 was produced in the same procedure as Example 1 except for changing the positive electrode active material. The aqueous rechargeable battery A3 was assessed on the basis of Evaluation 1 and 3.

### Comparative Example 3

In Comparative Example 3, an aqueous rechargeable battery B3 was produced in the same procedure as Example 3 except for omitting the step of forming the lithium ion-conducting solid electrolyte on the surface of the positive electrode precursor. In other words, the aqueous rechargeable battery B3 uses the positive electrode precursor of Example 3 as the positive electrode. The aqueous rechargeable battery B3 was assessed on the basis of Evaluation 1 and 3.

Evaluation results of Example 3 and Comparative Example 3 are shown in Table 3. In Table 3, the evaluation results of the aqueous rechargeable battery A3 are shown as cell A3 and the evaluation results of the aqueous rechargeable battery B3 as cell B3. In Table 3, the discharge capacities of the aqueous rechargeable battery A3 and the aqueous rechargeable battery B3 are shown in relative values with 100 for the discharge capacity of the aqueous rechargeable battery B3 of Comparative Example 3.

### Example 4

In Example 4, a lithium transition metal oxide (LiNi_{0.5}Co_{0.2}Mn_{0.3}O₂ (NCM)) was used as a positive electrode active material. An aqueous rechargeable battery A4 was produced in the same procedure as Example 1 except for changing the positive electrode active material. The aqueous rechargeable battery A4 was assessed on the basis of Evaluation 1 and 3.

### Comparative Example 4

In Comparative Example 4, an aqueous rechargeable battery B4 was produced in the same procedure as Example 4 except for omitting the step of forming the lithium ion-conducting solid electrolyte on the surface of the positive electrode precursor. In other words, the aqueous rechargeable battery B4 uses the positive electrode precursor of Example 4 as the positive electrode. The aqueous rechargeable battery B4 was assessed on the basis of Evaluation 1 and 3.

Evaluation results of Example 4 and Comparative Example 4 are shown in Table 4. In Table 4, the evaluation results of the aqueous rechargeable battery A4 are shown as cell A4 and the evaluation results of the aqueous rechargeable battery B4 as cell B4. In Table 4, the discharge capacities of the aqueous rechargeable battery A4 and the aqueous rechargeable battery B4 are shown in relative values with 100 for the discharge capacity of the aqueous rechargeable battery B4 of Comparative Example 4.

### Example 5

In Example 5, a lithium transition metal oxide (LiNi_{0.35}Co_{0.35}Mn_{0.30}O₂ (NCM)) was used as a positive electrode active material. An aqueous rechargeable battery A5 was produced in the same procedure as Example 1 except for changing the positive electrode active material. The aqueous rechargeable battery A5 was assessed on the basis of Evaluation 1 and 3.

### Comparative Example 5

In Comparative Example 5, an aqueous rechargeable battery B5 was produced in the same procedure as Example 5 except for omitting the step of forming the lithium ion-conducting solid electrolyte on the surface of the positive electrode precursor. In other words, the aqueous rechargeable battery B5 uses the positive electrode precursor of Example 5 as the positive electrode. The aqueous rechargeable battery B5 was assessed on the basis of Evaluation 1 and 3.

Evaluation results of Example 5 and Comparative Example 5 are shown in Table 5. In Table 5, the evaluation results of the aqueous rechargeable battery A5 are shown as cell A5 and the evaluation results of the aqueous rechargeable battery B5 as cell B5. In Table 5, the discharge capacities of the aqueous rechargeable battery A5 and the aqueous rechargeable battery B5 are shown in relative values with 100 for the discharge capacity of the aqueous rechargeable battery B5 of Comparative Example 5.

TABLE 2

| Cell | Discharge capacity | Change rate (mV/Hour) |
|---|---|---|
| A2 | 100 | −1.62 mV/Hour |
| B2 | 100 | −1.89 mV/Hour |

TABLE 3

| Cell | Discharge capacity | Change rate (mV/Hour) |
|---|---|---|
| A3 | 100 | −2.20 mV/Hour |
| B3 | 100 | −2.50 mV/Hour |

TABLE 4

| Cell | Discharge capacity | Change rate (mV/Hour) |
|---|---|---|
| A4 | 100 | −1.93 mV/Hour |
| B4 | 100 | −2.02 mV/Hour |

TABLE 5

| Cell | Discharge capacity | Change rate (mV/Hour) |
|---|---|---|
| A5 | 100 | −2.01 mV/Hour |
| B5 | 100 | −2.08 mV/Hour |

As shown in Tables 2 to 5, by introducing a lithium ion-conducting solid electrolyte into the positive electrode, the aqueous rechargeable batteries A2 to A5 of Examples 2 to 5 were able to lower the change rate in open-circuit voltage during storage in a charged state, without lowering the discharge capacity, compared with the aqueous rechargeable batteries B2 to B5 of Comparative Examples 2 to 5 that each use the same positive electrode active material. In other words, the aqueous rechargeable batteries A2 to A5 can be evaluated that storage stability in a charged state is improved, regardless of the composition of the positive electrode active material, compared with the aqueous rechargeable batteries B2 to B5.

Moreover, lowering effects on the change rate in open-circuit voltage during storage in a charged state were: lowering by 83.2% in the aqueous rechargeable battery A1 relative to the aqueous rechargeable battery B1; lowering by 14.2% in the aqueous rechargeable battery A2 relative to the aqueous rechargeable battery B2; lowering by 12.2% in the aqueous rechargeable battery A3 relative to the aqueous rechargeable battery B3; lowering by 4.2% in the aqueous rechargeable battery A4 relative to the aqueous rechargeable battery B4; and lowering by 3.6% in the aqueous rechargeable battery A5 relative to the aqueous rechargeable battery B5.

The positive electrode active material of the aqueous rechargeable battery A1 and the aqueous rechargeable battery B1 is LiNi_{0.88}Co_{0.09}Al_{0.03}O₂, the positive electrode active material of the aqueous rechargeable battery A2 and the aqueous rechargeable battery B2 is LiNi_{0.82}Co_{0.15}Al_{0.03}O₂, the positive electrode active material of the aqueous rechargeable battery A3 and the aqueous rechargeable battery B3 is LiNi_{0.55}Co_{0.30}Mn_{0.15}O₂, the positive electrode active material of the aqueous rechargeable battery A4 and the aqueous rechargeable battery B4 is LiNi_{0.5}Co_{0.2}Mn_{0.3}O₂, and the positive electrode active material of the aqueous rechargeable battery A5 and the aqueous rechargeable battery B5 is LiNi_{0.35}Co_{0.35}Mn_{0.30}O₂. Accordingly, it is concluded that by introducing a lithium ion-conducting solid electrolyte into the positive electrode, lowering effects on the change rate in open-circuit voltage during storage in a charged state increase as the Ni ratio increases in the transition metals of the positive electrode active material.

In particular, lowering effects on the change rate in open-circuit voltage during storage in a charged state are remarkable in the aqueous rechargeable batteries A1, A2, and A3 that have a Ni ratio of 0.55 or more in the transition metals. This is presumably because, as the Ni ratio increases in the transition metals of the positive electrode active material, suppressive effects on the exchange reaction between lithium ions in the lithium transition metal oxide as the positive electrode active material and protons generated upon decomposition of water in the electrolyte solution and/or suppressive effects on the insertion reaction of protons into lithium sites in the positive electrode active material in a charged state increase.

### INDUSTRIAL APPLICABILITY

The aqueous rechargeable battery according to the present disclosure is useful as an aqueous rechargeable battery used for, for example, a power supply for driving personal computers, cellphones, mobile devices, personal digital assistants (PDAs), handheld game consoles, video cameras, and so forth; for a main power supply or an auxiliary power supply for driving electric motors of hybrid electric vehicles, plug-in HEVs, and so forth; and for a power supply for driving power tools, vacuum cleaners, robots, and so forth.

### REFERENCE SIGNS LIST

11 Positive electrode current collector
12 Positive electrode active material layer
13 Positive electrode
14 Negative electrode current collector
15 Negative electrode active material layer
16 Negative electrode
17 Separator
18 Case

1. An aqueous rechargeable battery comprising:
a positive electrode including a positive electrode current collector and a positive electrode active material layer provided on a surface of the positive electrode current collector;
a negative electrode including a negative electrode current collector and a negative electrode active material layer provided on a surface of the negative electrode current collector; and
an aqueous electrolyte solution containing a lithium salt and water, wherein:
the positive electrode active material layer contains one or more positive electrode active materials and one or more lithium ion-conducting solid electrolytes; and
the positive electrode active materials include a lithium transition metal oxide.

2. The aqueous rechargeable battery according to claim 1, wherein the lithium ion-conducting solid electrolytes cover at least part of a surface of the positive electrode active materials.

3. The aqueous rechargeable battery according to claim 1, wherein the lithium ion-conducting solid electrolytes cover at least part of the surface of the positive electrode current collector.

4. The aqueous rechargeable battery according to claim 1, wherein:
the positive electrode active material layer further contains a conductive agent; and
the lithium ion-conducting solid electrolytes cover at least part of a surface of the conductive agent.

5. The aqueous rechargeable battery according to claim 1, wherein:
the lithium ion-conducting solid electrolytes include one or more lithium ion-permeable oxides X;
the oxides X are LiₓM¹O_{y} (0.5≤x<4, 1≤y<6) composed of elemental Li, elemental M¹, and elemental O (oxygen); and
the elemental M¹ is at least one selected from the group consisting of B, Al, Si, P, S, Ti, V, Zr, Nb, Ta, and La.

6. The aqueous rechargeable battery according to claim 5, wherein:
the lithium ion-conducting solid electrolytes include one or more compounds Y containing elemental fluorine;
the lithium ion-conducting solid electrolytes have a bond between elemental M² and the elemental fluorine; and
the elemental M² is at least one selected from the group consisting of Li, Na, Al, Mg, and Ca.

7. The aqueous rechargeable battery according to claim 5, wherein the oxides X include at least either of LiₓPO_{y} (1≤x<3, 3≤y<4) and LiₓSiO_{y} (2≤x<4, 3≤y<4).

8. The aqueous rechargeable battery according to claim 6, wherein the compounds Y include LiF.

9. The aqueous rechargeable battery according to claim 5, wherein:
the positive electrode active material layer contains a condensed polymer of the lithium ion-conducting solid electrolytes; and
the polymer contains the elemental Li, the elemental M¹, and the elemental O.

10. The aqueous rechargeable battery according to claim 1, wherein:
the positive electrode active materials include LiₐNi_{b}M³_{1-b}O₂ (0<a≤1.2, 0.3≤b≤1); and
M³ is at least one selected from the group consisting of Mn, Co, and Al.

11. The aqueous rechargeable battery according to claim 1, wherein:
the positive electrode active materials include LiₐNi_{b}M³_{1-b}O₂ (0<a≤1.2, 0.55≤b≤1); and
M³ is at least one selected from the group consisting of Mn, Co, and Al.

12. The aqueous rechargeable battery according to claim 1, wherein:
the positive electrode active materials include LiₐNi_{b}M³_{1-b}O₂ (0<a≤1.2, 0.8≤b≤1); and
M³ is at least one selected from the group consisting of Mn, Co, and Al.

13. The aqueous rechargeable battery according to claim 1, wherein the lithium salt is a lithium salt formed from a lithium cation and an imide anion.

14. The aqueous rechargeable battery according to claim 1, wherein the lithium salt is at least one selected from the group consisting of LiCF₃SO₃, LiN(SO₂CF₃)₂, LiN(SO₂CF₂)₂, LiN(SO₂C₂F₅)₂, and LiN(SO₂CF₃)(SO₂C₂F₅).

15. The aqueous rechargeable battery according to claim 1, wherein an amount of water relative to 1 mol of the lithium salt is 4 mol or less.

16. The aqueous rechargeable battery according to claim 1, wherein:
the positive electrode active material layer further contains a binder; and
the lithium ion-conducting solid electrolytes cover at least part of a surface of the binder.
